(19) United States
(12) Patent Application Publication
(10) Pub. No.: US 2023/0071971 A1
(43) Pub. Date: Mar. 9, 2023

(54) System and Methods for Efficiently Evaluating a Classifier

(71) Applicant: Ferrum Health Inc., Sunnyvale, CA (US)

(72) Inventors: Leon Bergen, San Diego, CA (US); Kenneth Ko, Santa Clara, CA (US)

(21) Appl. No.: 17/896,472

(22) Filed: Aug. 26, 2022

Related U.S. Application Data
(60) Provisional application No. 63/241,875, filed on Sep. 8, 2021.

(51) Int. Cl. G06N 20/00

(52) U.S. Cl. CPC G06N 20/00

(57) ABSTRACT

Embodiments are directed to systems, apparatuses, and methods for efficiently evaluating the performance of a machine learning classifier. Embodiments improve the efficiency of techniques used to evaluate a classifier by substituting labels which are inexpensive to generate or collect for labels which are relatively more expensive to generate or collect, reducing the number of samples that need to be labeled, and reducing the number of data samples that need to be input to a machine learning classifier to evaluate the classifier.

### CROSS REFERENCE TO RELATED APPLICATION

This application claims the benefit of U.S. Provisional Application No. 63/241,875, entitled “System and Methods for Efficiently Evaluating a Classifier,” filed Sep. 8, 2021, the disclosure of which is incorporated in its entirety by this reference.

### BACKGROUND

A classifier is a model or algorithm that is used to segment input data into a category, such as by indicating the likelihood of the presence or absence of some characteristic in the data, or by assigning an identifying label to a set of input data. Classifiers may also be used to determine an expected or “predicted” output based on a set of input data. Classifiers are often used in the processing of data sets and may be implemented in the form of trained machine learning (ML) models such as deep neural networks. Training such models requires a set of data items and an associated label or annotation for each item. Further, before a user can rely on the output of a model and use it as part of a decision process, the model is typically evaluated for its accuracy and reliability.

A conventional method for evaluating a classifier has two stages. First, a large dataset in the appropriate domain is collected, and a person provides ground-truth label(s) or annotations for each sample in the dataset. As an example, consider the implementation of a classifier for the presence of lung nodules in abdominal CT scans. For this example of a classifier, one would collect multiple abdominal CT scans or “studies”, and a human labeler would provide ground-truth labels for the presence or absence of lung nodules in the collected studies. The data and associated labels would then be used to “train” a model, typically by using a specific algorithm or methodology to produce the model.

Next, the trained classifier would be run on the collected dataset and its performance measured by comparing its “predictions” or outputs to the ground-truth labels for the dataset. This serves to validate the performance of the trained model against the set of known correct labels. In some cases, a portion of the data set that was previously separated out and not labeled, or a new data set may be used as input data to the classifier and the output(s) evaluated by a human reviewer.

However, both steps may involve significant “costs”, in terms of money, computational resources, and time. Labeling a dataset can require a large amount of time, as a person needs to manually label each data point. In addition, the labeling can often only be performed by a trained individual, whose labor costs can be substantial. For example, a radiologist may be required for labeling CT scans or other radiology images.

The second step in the evaluation process, running the classifier on the collected dataset, may also be costly. Some machine learning classifiers have significant computational costs, requiring long amounts of time on computing devices or servers to generate their predictions. Further, in some situations human (or machine generated) labeled training data may not be available. This may be due to human labor cost, regulatory issues which restrict data availability, or the desire to use a classifier in a novel environment, where no (or insufficient) data for human labeling has been collected.

In some situations, there are also other factors which can increase the costs involved in evaluating a classifier. Machine learning classifiers are built to distinguish two or more categories of data from each other. However, a classifier's performance in distinguishing the different categories can differ; for example, a classifier may be relatively accurate at detecting one category but not at another. In the case of a binary classifier (i.e., one trained to detect the presence or absence of a specific feature), performance is typically evaluated using the true positive rate (TPR, the fraction of positive examples that are labeled correctly by the classifier) and the false positive rate (FPR, the fraction of negative examples labeled correctly).

However, evaluating the TPR and FPR for a classifier typically requires collecting a large number (e.g., 200 or more) of positive examples, and a similar number of negative examples. This may be challenging and increase development costs when using datasets with highly imbalanced numbers of positive and negative outcomes. Such a situation may occur where there is an order of magnitude or greater difference between positive classifications (e.g., a tumor is present in an image) and negative classifications (no tumor is detected in an image) because of the normal frequency of a particular event or characteristic.

For example, scans containing a cancerous nodule will typically occur much less frequently than those without such nodules, making it difficult to collect a large enough number of positive scans without having to evaluate a much large number of scans. If cancerous nodules only occur in 1/100 studies, then 20,000 studies/scans will need to be collected to find 200 positives. This is a large (and often impractical) amount of data that needs to be labeled and classified for accurate evaluation of the classifier.

Note that this is but one example where conventional classifier evaluation approaches may not be efficient or in some cases, even feasible in a commercial sense. For example, evaluating a classifier intended for use in detecting a specific event, person, animal, or object in an image or a specific sound in an audio track may involve similar ratios of positive to negative outcomes and hence introduce similar concerns.

Embodiments are directed toward solving these and other problems related to the training and evaluation of classifiers individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

In some embodiments, the disclosed approach or method provides an efficient way to evaluate the performance of a machine learning classifier. In some embodiments, the described method may be implemented in the form of a system or apparatus, where the system or apparatus comprises a processor programmed to execute a set of computer-executable instructions. When executed, the instructions cause the system or apparatus to implement one or more steps or stages of the disclosed method.

In one embodiment, the disclosed method for more efficiently evaluating the performance of a machine learning classifier may include the following steps, stages, processes, elements, operations, or functions:
Obtain a 1^{st} set of Data Pairs for a 1^{st} and 2^{nd} Mode of Data from a Common Study;
   In some embodiments, each data pair is of an image (x-ray, CT, or scan, as examples) and a written or text “report” indicating the presence or absence of a characteristic of the image;
      In other embodiments, the 1^{st} and 2^{nd} mode of data may comprise video and audio, video and text, audio and text, or time-varying electronic signals and text indicating the presence of a target, as non-limiting examples;
Determine if Labeling or Annotating One Mode of Data in a Pair Is Less “Expensive” Than Labeling or Annotating the Other Mode of Data in the Pair;
   Where the “cost” may be a function of the human labor, data storage, time, or computational resources required, as non-limiting examples;
Evaluate The Performance of a Classifier For The Less Expensive Data Mode, Where This May Include One or More of The Following;
   Label or Annotate the Less “Expensive” Mode of the Data Pair as Indicating the Presence or Absence of the Characteristic;
   Operate the Classifier for the Less Expensive Mode to Select a Subset 1 of Data Indicating the Presence and Absence of the Characteristic (based on outputs of the classifier);
   Review, Label, or Annotate Subset 1 of Data by a Person to Produce a Set of Correctly Labeled Data of the Less Expensive Mode;
   Based on the Correctly Labeled Data, Evaluate the Performance of the Classifier for the Less Expensive Mode (e.g., determine the PPV and NPV for that Classifier);
Obtain a 2^{nd} Set of Data Pairs for the 1^{st} and 2^{nd} Modes of Data;
Operate the Classifier for the Less Expensive Data Mode to Select a Subset 2 of Data from the 2^{nd} Set Indicating the Presence or Absence of the Characteristic;

Operate the Classifier for the More Expensive Data Mode on the Subset 2 of Data; and
Estimate the Performance of the Classifier for the More Expensive Mode of Data Based on the Output of the Classifier for the More Expensive Mode Compared to the Output of the Classifier for the Less Expensive Mode;
   As will be described, this may be based on direct estimation of matrix elements when labeling costs are high or the prevalence of positive study results are low or be based on application of the Bayes rule when labeling costs are low or the prevalence of positive study results are high.

In one embodiment, the disclosure is directed to a system for more efficiently evaluating the performance of a machine learning classifier. The system may include a set of computer-executable instructions stored in (or on) a data storage device or memory and an electronic processor or co-processors. When executed by the processor or co-processors, the instructions cause the processor or co-processors (or a device of which they are part) to perform a set of operations that implement an embodiment of the disclosed method or methods.

In one embodiment, the disclosure is directed to a non-transitory computer readable medium containing a set of computer-executable instructions, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed herein may provide services through a SaaS or multi-tenant platform. The platform provides access to multiple entities, each with a separate account and associated data storage. Each account may correspond to a user, a set of users, an entity, a set or category of entities, a set or category of users, a set or category of data, an industry, or an organization, for example. Each account may access one or more services, a set of which are instantiated in their account, and which implement one or more of the methods or functions described herein.

In contrast to the conventional approaches to evaluating a classifier, embodiments of the approach and methodology described herein improve the efficiency of techniques used to evaluate a classifier in one or more of the following ways:
By substituting labels which are (relatively) inexpensive to generate or collect for labels which are more expensive to generate or collect;
By reducing the number of samples that need to be labeled; and
By reducing the number of data samples that need to be input to a machine learning classifier to evaluate the classifier.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and are described in further detail herein. However, the exemplary or specific embodiments are not intended to be limited to the particular forms described. Rather, the present disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1 is a flowchart or flow diagram illustrating a process, method, operation, or function for evaluating a classifier that may be used in implementing some embodiments;

FIG. 2 is a diagram illustrating elements or components that may be present in a computer device or system configured to implement a method, process, function, or operation in accordance with some embodiments of the systems, apparatuses, and methods described herein; and

FIGS. 3-5 are diagrams illustrating an architecture for a multi-tenant or SaaS platform that may be used in implementing an embodiment of the systems, apparatuses, and methods described herein.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter will be described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that this disclosure will satisfy the statutory requirements and convey the scope of the disclosure to those skilled in the art.

Among other forms, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by a suitable processing element or elements (such as a processor, co-processor, microprocessor, CPU, GPU, TPU, QPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user over a network (e.g., the Internet) through a transfer of instructions or an application that executes a set of instructions.

In some embodiments, the systems and methods disclosed herein may provide services to end users through a SaaS or multi-tenant platform. The platform provides access to multiple entities, each with a separate account and associated data storage. Each account may correspond to a user, a set of users, an entity, a set or category of entities, a set or category of users, a set or category of data, an industry, or an organization, for example. Each account may access one or more services (such as applications or functionality), a set of which are instantiated in their account, and which implement one or more of the methods, process, operations, or functions disclosed herein.

In some embodiments, one or more of the operations, functions, processes, or methods disclosed herein may be implemented by a specialized form of hardware, such as a programmable gate array, application specific integrated circuit (ASIC), or the like. Note that an embodiment of the disclosed methods may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, embodiments of the approach and methodology described herein improve the efficiency of techniques used to evaluate a classifier in one or more of the following ways:
By substituting labels which are (relatively) inexpensive to generate or collect for labels which are more expensive to generate or collect;
By reducing the number of samples that need to be labeled; and
By reducing the number of data samples that need to be input to a machine learning classifier to evaluate the classifier.
   Each of these areas of improvement is described in greater detail herein.

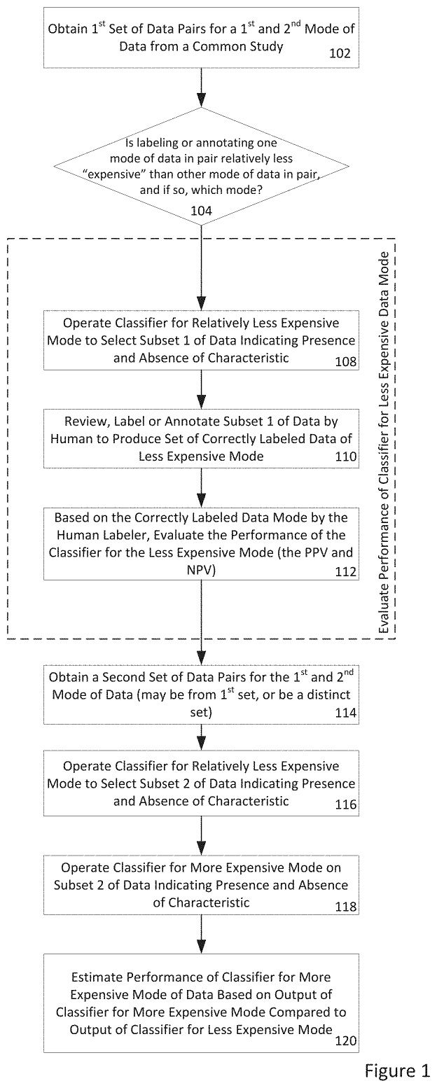

FIG. 1 is a flowchart or flow diagram illustrating a process, method, operation, or function for evaluating a classifier that may be used in implementing some embodiments. As shown in the figure, a (1^{st}) set of pairs of data from a study are collected, where each data element in the pair is of a different mode or type (such as an image, text, or an audio file), as suggested by step or stage 102. A classifier is available for each mode of data, such as an image classifier and a text classifier.

In one embodiment, each pair of data includes an image (x-ray, CT, or scan, as non-limiting examples) and a written or text “report” indicating the presence or absence of a characteristic of the image. The characteristic may be a tumor, a person, a structure, an animal, or an event, as non-limiting examples.

Next, it is determined whether one mode of data is (relatively) less expensive to label or annotate (as suggested by step or stage 104), and if so, which mode that is. For example, a written report may represent a less expensive form of data to annotate, while a complex image may represent a more expensive form of data to annotate.

Next (as suggested by the set of processing stages in the box labeled “Evaluate Performance of Classifier for Less Expensive Data Mode”), a set of processing steps are performed to evaluate the performance of a classifier, for example an NLP, Language, or Text classifier:
(a) Operate a Classifier for the Relatively Less Expensive Mode to Select Subset 1 of Data Indicating the Presence and/or Absence of a Characteristic (as suggested by step or stage 108);
(b) Review, Label or Annotate Subset 1 of Data by a Human to Produce a Set of Correctly Labeled Data of the Less Expensive Mode (step or stage 110); and
(c) Based on the Correctly Labeled Data Mode by the Human Labeler, Evaluate the Performance of the Classifier for the Less Expensive Mode (the PPV and NPV) (step or stage 112).

Next, a 2^{nd} set of pairs of data is obtained, where the data elements in a pair are of the same two modes, and typically would be from the same study (although the data elements could also be obtained from a different study), as suggested by step or stage 114. The 2^{nd} set of data pairs may be the same or a subset of the 1^{st} set of data pairs or may be a distinct set of data pairs. This is followed by a step or stage of Operating the Classifier for the Relatively Less Expensive Mode to Select [a] Subset 2 of Data from the 2^{nd} Data Set Indicating the Presence and/or Absence of a Characteristic (as suggested by step or stage 116), where the characteristic may be the presence or absence of a nodule, tumor, person, animal, item, event, or condition, as non-limiting examples.

Next, at step or stage 118, the process includes Operating the Classifier for the More Expensive Mode on Subset 2 of the Data Indicating the Presence and/or Absence of the Characteristic. This step or stage provides a set of outputs or classifications that can be compared to those from the other classifier, whose performance can be evaluated more easily or efficiently.

At step or stage 120, the disclosed process can Estimate the Performance of the Classifier for the More Expensive Mode of Data Based on the Output of the Classifier for the More Expensive Mode Compared to the Output of the Classifier for the Less Expensive Mode. As will be described, this estimation or evaluation of classifier performance may be based on direct estimation of conditional probabilities when labeling costs are high or the prevalence of a positive study is low or instead based on application of Bayes rule when labeling costs are low or the prevalence of a positive study is high.

Note that in some embodiments, the first set of data may consist of only one type or mode of data, such as the type that is less “expensive” or resource demanding to annotate. Further, in some embodiments, the second set of data may be obtained from a different study than the study that produced the first set of data. In some uses, the first set of data may be collected prior to the second set of data. This may be advantageous if one type or mode of data is only available after a certain date. In other uses, both modes of data may be available but restricting the first set of data to the first mode will reduce the cost of data acquisition. In another potential use case, the two datasets may be identical, or the first dataset may be a randomly sampled subset of the second dataset.

Further, although the use of an x-ray or other type of image to identify a nodule or tumor is mentioned as an example, note that other applications of the methods and techniques described herein may include uses where the image is a CT, MRI, x-ray, PET, or other medical imaging modality, and the characteristic being identified is an imaging abnormality, such as a fracture, aneurysm, or lesion, as non-limiting examples. The more “expensive” mode of data may be another medical recording modality, such as EEG or ECG, and the characteristic being identified is an abnormality identified in this data record or recording. In some use cases, the “expensive” mode of data is a set or sequence of measurements from which a binary characteristic can be identified.

To be able to substitute (relatively) inexpensively obtained labels for (relatively) more expensive labels, assume that each point in the dataset consists of a pair of data. In the radiology example described, each point consists of an image/text report pair, where the text report is generated by a radiologist and provides a description of the image (such as whether it shows or fails to show a tumor or nodule). These pairs of data are generated during the ordinary course of operation at a hospital or as part of a radiology practice.

There are other situations where pairs of related or matched data are generated, with each element belonging to a different modality (text, image, video, audio, or time-varying signals, as non-limiting examples). For example, video files may have an accompanying audio narration, audio files may be paired with text transcriptions, or images may be paired with text captions.

When such pairs of data are available, it may be the case that one element of the data pair may be easier to label than the other (that is, there is a difference in the “cost” associated with labeling or annotating each of the two items, modes, or types of data). For example, in the radiology context described, text is typically easier and less costly to label than images. In this example, it is noted that a trained radiologist is not needed to read a report and indicate whether the report mentions the presence or absence of a feature in the image.

Therefore, a strategy for decreasing the cost of labeling or annotating a data set is straightforward in this situation: label the text descriptions rather than the images themselves and use the text labels to evaluate the performance of an image classifier. In general, this strategy may be described as a heuristic or guiding principle: label the data type that is less expensive to label and use those labels as a proxy for the other modality's labels.

This guide or heuristic to identify the “less expensive” data mode to annotate should be straight forward to implement in cases where a written report accompanies a set of data, such as an image, an audio track, or a set of signals. However, in some cases, it may be less expensive in terms of money, computational time, or human (expert) time to evaluate the presence or absence of a specific characteristic of an image, audio track, or set of signals than to read a detailed report or analysis (particularly one that contains technical or case-specific terms of art).

Further, although this strategy is likely to be effective at decreasing labeling “costs”, there are still possible problems. First, a large amount of data may still need to be manually labeled, based on the relative frequency of occurrence of a positive as opposed to a negative classification. Second, the target classifier may still need to be run on a large amount of data for proper evaluation. The next sections describe approaches to solving (or at least reducing the burden of) these potential problems.

As mentioned, evaluating the performance of a classifier requires the availability of a “sufficient” number of examples in each category, e.g., 200 positive and 200 negative examples. When one category is of a low (or lower) prevalence or rate of occurrence, this requires labeling a large amount of data to find a sufficient number of samples from that category.

To address this problem, some embodiments disclosed herein utilize a second classifier to prioritize data for human labeling. In the radiology example where both an image and a written or text report are available, one would implement this approach by using an NLP or text classifier, which generates a positive output if the text describes the presence of a lung tumor or nodule, and a negative output otherwise.

The NLP or text classifier is applied to a sufficiently large number of reports. From these reports, one selects a subset that have been labeled positive by the classifier, and a separate subset that have been labeled negative. Assuming that the NLP classifier is (relatively) accurate, the NLP-positive subset will contain a higher (typically a much higher) density (percentage) of positive reports than would a randomly selected subset. By prioritizing these NLP-selected reports for human labeling, one can reduce the expected number of reports that need to be human-labeled to obtain the desired number of positive and negative samples. This approach may be described as “assume an accurate enough classifier is available for operating on one modality of data and select the positive outputs of the classifier as candidates for human labeling”.

This technique may be sufficient on its own to generate enough useful data and labels, if both classifiers (in this case, the image and text classifiers) can be applied to the same dataset. This would be expected to occur if complete pairs (e.g., both the text reports and their corresponding radiology images) are available for the data points (or for a large enough fraction of them) that are intended to be human-labeled.

However, there are situations where this assumption may not be satisfied. Consider a situation in which one wants to perform continuous validation of a machine learning classifier, i.e., to monitor whether the classifier's performance changes over time. In this case, one would need to collect human-generated labels for each new round of evaluation. This may be unrealistic because of the cost (in time and money) of this additional labeling or because in some situations human access to sensitive data may be limited, as examples.

Alternately, consider a situation in which one wants to evaluate a new classifier. To reuse the same labeled dataset as used with a previously evaluated classifier, one would need to store the previously used dataset. Maintaining a dataset has infrastructure costs, and in some cases, e.g., for medical images, there can be a prohibitive amount of data storage space required. In such situations, the disclosed method can be modified, as described below. There may also be issues of data privacy and a desire to minimize disruption of an organization's operations that reduce the practicality of obtaining a new data set for use in evaluating a new classifier.

An approach to overcoming the disadvantages associated with maintaining/storing an existing dataset or assembling and labeling a new set of data is to separate the dataset that is human-labeled from the dataset that is used for model evaluation. By doing this, the disclosed approach eliminates the need to collect human labels each time a model is evaluated. In addition, the disclosed method preserves the advantages of the previous approach, as it requires only a limited number of human-generated labels.

The process to be described may be implemented in two stages. First, a dataset of radiology reports (more generally, data from one modality) is collected. The NLP/text classifier is run on this dataset, and as described previously, a subset of NLP-positive and a subset of NLP-negative reports are selected for human labeling.

The performance of the NLP or text classifier is then evaluated using the human labels. Note, however, that it is not possible to use labels collected in this manner to estimate the TPR and FPR of the classifier, as the method does not produce a random sample of positive and negative reports. Instead, the labels are used to evaluate the Positive Predictive Value (PPV) and Negative Predictive Value (NPV) of the classifier. The discussion below explains why determining the PPV and NPV are sufficient in this situation.

Next, a second and potentially distinct dataset of image/report pairs is collected. The reports may be the same (or overlap) with those that were used to determine the PPV/NPV of the NLP classifier, or alternately may be a distinct set drawn from the same distribution. The NLP classifier is run on the data pairs in each study in this dataset, and subsets of NLP-positive and NLP-negative studies are selected. If the NLP classifier is (relatively) accurate, then the NLP-positive studies will be enriched (i.e., they will have a higher proportion of positives than would occur in a randomly selected subset of data) for studies that contain lung nodules, and similarly for the NLP-negative studies. The visual/image classifier is then run on this subset of studies. The performance (TPR and FPR) of the visual classifier can be estimated by comparing the output of the visual classifier to the NLP classifier, using the calculations and processing flow described below.

Thus, in some embodiments, the disclosed approach uses an NLP classifier to prioritize which studies should be labeled, and which studies a visual/image classifier should be run on. By doing this, the disclosed approach reduces the number of reports that need to be labeled, and the number of studies (image and text data pairs) that need to be input to the visual classifier. In some embodiments, the performance estimates for the NLP classifier can be used for evaluations of a new visual classifier or for evaluation of the existing visual classifier operating on a new dataset, and this eliminates the need to obtain new report labels.

As disclosed, the proposed method or processing flow decreases the number of studies that need to be processed by a vision/image model or classifier. If the NLP algorithm used is sufficiently accurate, then the described procedure may decrease the number of studies needed by a factor of 50 in low-prevalence situations (i.e., situations in which the occurrence of a positive classification is (relatively) low compared to a negative one). In one embodiment, for the disclosed approach to provide a reliable output, it is sufficient for the TPR of the NLP classifier to be greater than 0.5, and its FPR to be less than 0.5 (i.e., for the NLP classifier performance to be better than that due to chance). As a non-limiting example, the disclosed procedure may be performed as follows:
1. Estimate the conditional probability P(S|L), i.e., the probability that a study (S) is positive/negative given that the NLP classifier (L) output is positive/negative. This defines the PPV and NPV for the NLP classifier. Recall that it is assumed that the reports provide accurate ground-truth labels for the images; that is, the variable S represents whether both the image and report contain a nodule/description of a nodule. The probability can be estimated in two different ways, as described with reference to Case 1 and Case 2 below;
2. Label studies with the NLP algorithm until at least kₚ (˜200) studies have been labeled positive (the exact number depends on the accuracy of the NLP algorithm and the prevalence of the disease, as described below) and kₙ (˜200) have been labeled negative. Note that if more than kₙ negatives are collected, then the excess can be discarded;
3. Run/execute the vision/image algorithm or classifier on the studies that have been collected; and
4. Using the known performance behavior of the NLP algorithm or classifier, perform the calculations below and thereby infer the performance of the vision algorithm or classifier.

Assume a joint distribution on Studies (S), NLP algorithm (L) and vision algorithm (V) may be factored as follows:

P(S,L,V)=P(S)P(L|S)P(V|S)

This represents an assumption that the NLP and vision classifiers make errors independently of each other. The independence assumption means that if a study is positive, then the fact that the language classifier made an error does not influence the probability of the visual classifier making an error.

During the data collection described, one can directly estimate the conditional probability that the vision algorithm will be positive/negative given an NLP label. That is, for the kₚ studies labeled positive by the NLP algorithm or classifier, operate the vision algorithm or classifier to estimate P(V=T|L=T). Similarly, for the kₙ studies labeled negative by the NLP algorithm or classifier, operate the vision algorithm or classifier to estimate P(V=T|L=F).

An observation is that the conditional distributions of the vision classifier given the NLP classifier (P(V|L)) are completely determined by (a) the conditional distributions P(S|L) and (b) the vision classifier performance distributions P(V|S). Based on this observation, the following pair of equations are obtained from the possible outcomes:

$$P ( V = T \vert L = T ) = P ( S = T \vert L = T ) \cdot P ( V = T \vert S = T ) + P ( S = F \vert L = T ) \cdot P ( V = T \vert S = F )$$

$$P ( V = T \vert L = F ) = P ( S = T \vert L = F ) \cdot P ( V = T \vert S = T ) + P ( S = F \vert L = F ) \cdot P ( V = T \vert S = F )$$

Notice that this is a matrix equation of the form b=Ax, where:

$$x = [ \begin{matrix}P ( V = T \vert S = T ) \\ P ( V = T \vert S = F )\end{matrix} ]$$

$$b = [ \begin{matrix}P ( V = T \vert L = T ) \\ P ( V = T \vert L = F )\end{matrix} ]$$

$$A = [ \begin{matrix}P ( S = T \vert L = T ) & P ( S = F \vert L = T ) \\ P ( S = T \vert L = F ) & P ( S = F \vert L = F )\end{matrix} ]$$

As noted above, the elements of b can be estimated from the data collected. The matrix A, which represents the performance of the NLP algorithm or classifier, can be estimated in two ways, described with reference to Cases 1 and 2 below.

Recall that a goal is to estimate x, the performance of the vision algorithm:

$$x = [ \begin{matrix}P ( V = T \vert S = T ) \\ P ( V = T \vert S = F )\end{matrix} ]$$

This can be computed by matrix inversion:

x=A⁻¹b

The variance of this estimator for x will increase with the variance of the estimator for b. In general, this can be reduced by labeling more studies with the NLP algorithm or classifier, in Step 2 of the Data Processing Flow described previously. The exact number of studies that need to be labeled, to achieve a target variance for the estimator of x, depends on the TPR/FPR of the NLP and visual classifiers, and the prevalence of positive studies. It is expected that no more than 200 positive and 200 negative studies will need to be labeled to achieve low enough variance for most use cases.

For some use cases, a greater number of positive and negative studies may be required if at least one of the following two conditions are met: 1) the PPV or NPV of the NLP classifier is close to 0, due to imbalanced class frequencies or poor classifier performance; or 2) the use case requires a high degree of certainty about the performance of the visual classifier. As will be recognized by one of ordinary skill in the art, it is straightforward to use the formulas presented herein to estimate the number of studies required to achieve a desired level of variance.

### Estimating the Matrix A: Case 1

A goal is to estimate the conditional distribution of the study variable S result given the output of the NLP algorithm or classifier L. This can be done as follows:
1. Label a set of reports with the NLP classifier;
2. Collect the reports that have been labeled positive by the NLP classifier. Human-label enough reports such that ˜200 are labeled positive by a human. For a disease with 1/1000 prevalence, this should not require more than a few thousand reports;
3. Collect the reports that have been labeled negative by the NLP classifier. Human-label a few hundred of these reports.

Using the NLP-positive reports that have been human labeled, one can directly estimate P(S=T|L=T) and P(S=F|L=T). Similarly, using the NLP-negative reports that have been human labeled, one can directly estimate P(S=T|L=F) and P(S=F|L=F). These are the quantities needed to estimate the matrix A. This method is preferable when report labeling costs are high, or when the prevalence of positive studies is low.

The variance of the estimation of the matrix inverse of A (that is A⁻¹) is closely related to the determinant of A. This can cause computational problems when the determinant of A is sufficiently small, which occurs when two rows of A are similar enough to each other. Recall that the rows represent the PPV and NPV of the NLP classifier. In most situations, it is expected that the PPV and NPV of the NLP classifier will be such that the determinant will be sufficiently large enough to avoid the computational problems.

In low prevalence situations, the FPR of the NLP classifier is preferably sufficiently low to offset the effect on the PPV. For example, if the prevalence of a situation or characteristic is 1/1000, then the FPR is preferably no greater than 1/100, such that the PPV can remain greater than 0.1. If the FPR is too large in this case, for example 1/10, then the PPV will be only 0.01, resulting in poor data efficiency for the method.

Estimating the matrix A: Case 2

There is also a second method that may be used to estimate the distribution P(S|L). Assume that the prevalence P(S) of a characteristic and the NLP classifier performance P(L|S) are known. These values can be estimated by human-labeling a sufficiently large enough number of randomly selected reports. Note that this approach scales poorly when the prevalence of the characteristic (such as a disease or tumor) is low: in that situation, one would need to human label an excessive or infeasible number of reports to capture enough positive results. For example, if the prevalence of positive studies is 1/1000, then one would need to sample 100,000 studies to collect 100 positives; typically, at least 100 positives are necessary to reliably estimate the quantity P(L|S=True).

Given that a study has been labeled positive/negative by an NLP classifier, one can compute the conditional probability that the study is positive or negative, using an application of Bayes' Rule:

$$P ( S = T \vert L = T ) = \frac{P ( L = T \vert S = T ) P ( S = T )}{P ( L = T )}$$

This approach should be most appropriate for higher prevalence characteristics, and when labeling costs are relatively low. An advantage of this method over the one described with reference to Case 1 is that it separately estimates the prevalence and the values for the FPR/TPR. In some situations, the prevalence may change, without any changes in the FPR/TPR, in which case these estimates can be reused.

The method(s) described provide a static estimate of the performance of a classifier. However, in some situations, a classifier's performance may change over time. For example, the distribution of a disease among patients may change due to seasonal or other factors, the machine used to collect CT or MRI images may be changed or change its performance, or the human processes used to collect images may change over time. These types of changes in the distribution of data are referred to as “data drift” and may occur when machine learning models are used over an extended period.

An extension to the proposed estimation method can be used to detect whether data drift is occurring. More specifically, it can estimate changes in the values of FPR or TPR over time. The extended method is similar to the processing method(s) described previously, with a difference being in the estimation of P(V|L). Rather than assume that this quantity is static, the approach instead estimates a separate Pₜ(V|L) for each time t. Following the rest of the procedure as described, this leads to a separate estimate of the visual classifier FPR/TPR at time t.

To estimate Pₜ(V|L) consider a time-discounted sum of classifier output counts. Define the indicator variables

$${1}_{t , V} = \{ \begin{matrix}1 if classifier V outputs True at time t \\ 0 otherwise\end{matrix}$$

$${1}_{t , L} = \{ \begin{matrix}1 if classifier L outputs True at time t \\ 0 otherwise\end{matrix}$$

An estimate of Pₜ (V=T|L=T) can then be calculated by:

$${P}_{t} ( V = T \vert L = T ) = \frac{{\sum }_{{t}^{′ = {t}_{a}}}^{{t}^{′} = {t}_{b}} {e}^{λ \vert t - {t}^{′} \vert} {1}_{{t}^{′} , V} {1}_{{t}^{′} , L}}{{\sum }_{{t}^{′ = {t}_{a}}}^{{t}^{′} = {t}_{b}} {e}^{λ \vert t - {t}^{′} \vert} {1}_{{t}^{′} , L}} .$$

Note that this formula is identical to the standard formula for estimating P(V=T|L=T), except those observations farther away from time t are given less weight. A similar formula can be used to estimate Pₜ(V=T|L=F). Given these two quantities, a time-specific estimate of P(V=T|S=T) and P(V=T|S=T) can be calculated using the method(s) disclosed.

There is also an alternate method for estimating the FPR and TPR values of the visual classifier. The alternate method uses as an input the same matrix A that is used for the previously described method(s). In addition, the alternate method uses a new type of human-labeled data which may be routinely collected under some conditions. By combining these two inputs—the matrix A and the new type of labeled data—the approach produces a partially independent estimate of the FPR and TPR. By averaging the estimates from the two methods, one can reduce noise and arrive at an accurate estimate faster.

The current method assumes that human labels are available for a subset of studies on which the visual classifier and language classifier are both run. Specifically, it assumes that Study labels (labels for the variable S) are available for studies in which L=0 and V=1. With slight modifications, the method will work when labels are available for other specific settings of L and V. A modification required is the substitution of the new values of L and V for the previous values L=0 and V=1.

Using the human labels for S, the process can directly estimate two quantities: P(S=T|L=F,V=T) and P(S=F|L=F,V=T). Using the assumption that L and V are conditionally independent given S, these two quantities can be represented as:

$$P ( S = T \vert L = F , V = T ) = \frac{P ( S = T ) P ( L = F \vert S = T ) P ( V = T \vert S = T )}{P ( L = F , V = T )}$$

$$P ( S = F \vert L = F , V = T ) = \frac{P ( S = F ) P ( L = F \vert S = F ) P ( V = T \vert S = F )}{P ( L = F , V = T )}$$

Note that the right-hand side of the equations contains the two quantities that it is desired to estimate: the visual classifier TPR−P(V=T|S=T) and the classifier FPR−P(V=T|S=F).

The denominator in the two equations, P(L=F,V=T), can be estimated by running the language and visual classifiers on a set of studies, and counting the number of times that L=F and that V=T. To estimate the visual classifier TPR and FPR, a remaining need is to estimate P(S=T)P(L=F|S=T) and P(S=F)P(L=F|S=F). This can be done using the matrix A, as it contains estimates for the quantities P(S=T|L=F) and P(S=F|L=F). The first quantity can be written as:

$$P ( S = T \vert L = F ) = \frac{P ( S = T ) P ( L = F \vert S = T )}{P ( L = F )}$$

The denominator in this quantity can be estimated by running the language classifier on a number of studies and counting the occurrences of a “False” output. Given an estimate of both the denominator and the left-hand side, one can then obtain an estimate of P(S=T)P(L=F|S=T). Further, P(S=F)P(L=F|S=F) can be estimated in a similar manner. This enables estimation of the values for FPR and TPR.

The following properties are believed to be distinctive to embodiments of the disclosure and an implementation of the described processing flow:
1. The process uses a classifier for modality A to determine the performance of a classifier for modality B;
2. The process only estimates the PPV and NPV for classifier A; labels are collected by sampling data points conditional on the outcome of classifier A; or
3. The process collects data that will be used for evaluation classifier B, by sampling data points conditional on the outcome of classifier A.

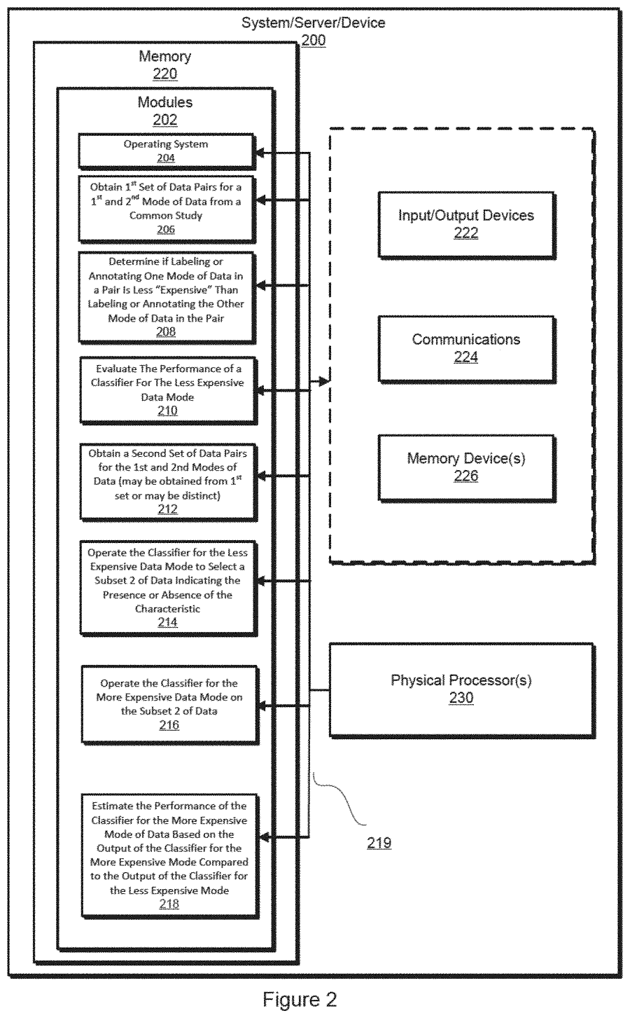

FIG. 2 is a diagram illustrating elements or components that may be present in a computing device, server, or system 200 configured to implement a method, process, function, or operation in accordance with an embodiment of the system and methods disclosed herein. As noted, in some embodiments, the system and methods may be implemented in the form of an apparatus that includes a processing element and set of executable instructions. The executable instructions may be stored in a memory or data storage element and be part of a software application and arranged into a software architecture.

In general, an embodiment may be implemented using a set of software instructions that are designed to be executed by a suitably programmed processing element (such as a GPU, CPU, TPU, QPU, state machine, microprocessor, processor, or controller, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement one or more aspects of the disclosed system and methods.

The application modules and/or sub-modules may include any suitable computer-executable code or set of instructions (e.g., as would be executed by a suitably programmed processor, co-processor, microprocessor, or CPU, as non-limiting examples), such as computer-executable code corresponding to a programming language. For example, programming language source code may be compiled into computer-executable code. Alternatively, or in addition, the programming language may be an interpreted programming language such as a scripting language.

Modules 202 shown in FIG. 2 may contain one or more sets of instructions for performing a method or function described with reference to the Figures, and the disclosure of the functions and operations provided in the specification. These modules may include those illustrated but may also include a greater number or fewer number than those illustrated.

As mentioned, each module may contain a set of computer-executable instructions. The set of instructions may be executed by a programmed processor or co-processor contained in a server, client device, network element, system, platform, or other component. The computer-executable instructions that are contained in the modules or in a specific module may be executed by the same processor or by different processors. Further, the computer-executable instructions that are contained in a single module may be executed (in whole or in part) by one processor (or co-processor) or by more than one processor (or co-processor).

A module (or sub-module) may contain instructions that are executed by a processor (or co-processor) contained in more than one of a server, client device, network element, system, platform or other component. Thus, in some embodiments, a plurality of electronic processors, with each being part of a separate device, server, or system may be responsible for executing all or a portion of the software instructions contained in an illustrated module. Thus, although FIG. 2 illustrates a set of modules which taken together perform multiple functions or operations, these functions or operations may be performed by different devices or system elements, with certain of the modules (or instructions contained in those modules) being associated with those devices or system elements.

As shown in FIG. 2, system 200 may represent a server or other form of computing or data processing system, platform, or device. Modules 202 each contain a set of executable instructions, where when the set of instructions is executed by a suitable electronic processor or processors (such as that indicated in the figure by “Physical Processor(s) 230”), system (or server, platform, or device) 200 operates to perform a specific process, operation, function, or method. Modules 202 are stored in a memory 220, which typically includes an Operating System module 204 that contains instructions used (among other functions) to access and control the execution of the instructions contained in other modules.

The modules 202 stored in memory 220 are accessed for purposes of transferring data and executing instructions by a “bus” or communications line 219, which also serves to permit processor(s) 230 to communicate with the modules for purposes of accessing and executing a set of instructions. Bus or communications line 219 also permits processor(s) 230 to interact with other elements of system 200, such as input or output devices 222, communications elements 224 for exchanging data and information with devices external to system 200, and additional memory devices 226.

In some embodiments, the modules 202 may comprise computer-executable software instructions that when executed by one or more electronic processors cause the processors or a system or apparatus containing the processors to perform one or more of the steps or stages of:
Obtain a (1^{st}) Set of Data Pairs for a 1^{st} and 2^{nd} Mode of Data from a Common Study (as suggested by Module 206);
   In some embodiments, each pair is of an image (x-ray, CT, scan) and a written or text “report” indicating the presence or absence of a characteristic of the image. The characteristic may be the presence or absence of a nodule, a tumor, a person, an animal, an event, a sign, a specific type of signal, etc. displayed in an image or waveform (as examples);
      In other embodiments, the 1^{st} and 2^{nd} mode of data may comprise video and audio, video and text, audio and text, or time-varying electronic signals and text indicating the presence of a target, as non-limiting examples;
Determine if Labeling or Annotating One Mode of Data in a Pair Is Less “Expensive” Than Labeling or Annotating the Other Mode of Data in the Pair (Module 208);
   For example, a written report may be relatively less expensive to label by indicating whether the report indicates the presence or absence of the characteristic versus evaluating a complex image, where “cost” may be a function of human labor, data storage, time, or computational resources required, as examples;
Evaluate The Performance of a Classifier For The Less Expensive Data Mode, Where This May Include One or More of The Following (Module 210);
   Label or Annotate the Less “Expensive” Mode of the Data Pair as Indicating the Presence or Absence of the Characteristic;
   Operate the Classifier for the Less Expensive Mode to Select a Subset 1 of Data Indicating the Presence and Absence of the Characteristic (based on outputs of the classifier);
   Review, Label, or Annotate Subset 1 of Data by a Person to Produce a Set of Correctly Labeled Data of the Less Expensive Mode;
   Based on the Correctly Labeled Data, Evaluate the Performance of the Classifier for the Less Expensive Mode (e.g., determine the PPV and NPV for that Classifier);
Obtain a 2^{nd} Set of Data Pairs for the 1^{st} and 2^{nd} Modes of Data (Module 212);
   The 2^{nd} set of data pairs may be the same or a subset of the 1^{st} set of data pairs or may be a distinct set of data pairs;
Operate the Classifier for the Less Expensive Data Mode to Select a Subset 2 of Data from the 2^{nd} Set of Data Indicating the Presence or Absence of the Characteristic (Module 214);
Operate the Classifier for the More Expensive Data Mode on the Subset 2 of Data (Module 216);
Estimate the Performance of the Classifier for the More Expensive Mode of Data Based on the Output of the Classifier for the More Expensive Mode Compared to the Output of the Classifier for the Less Expensive Mode (Module 218);
   As described herein, this may be based on direct estimation of matrix elements when labeling costs are high or the prevalence of positive study results are low or be based on application of the Bayes rule when labeling costs are low or the prevalence of positive study results are high.

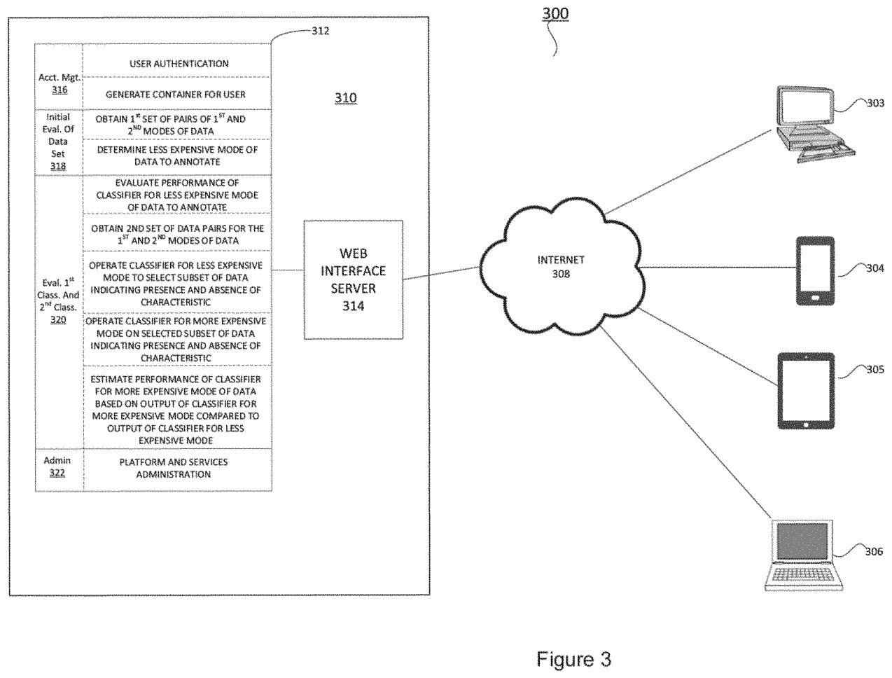

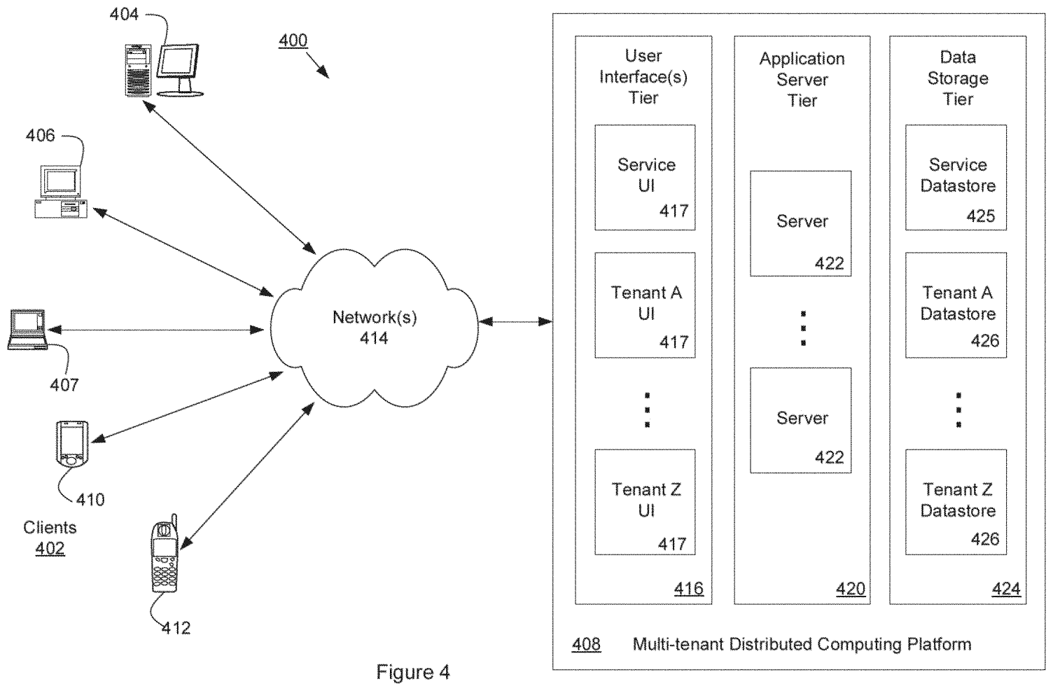

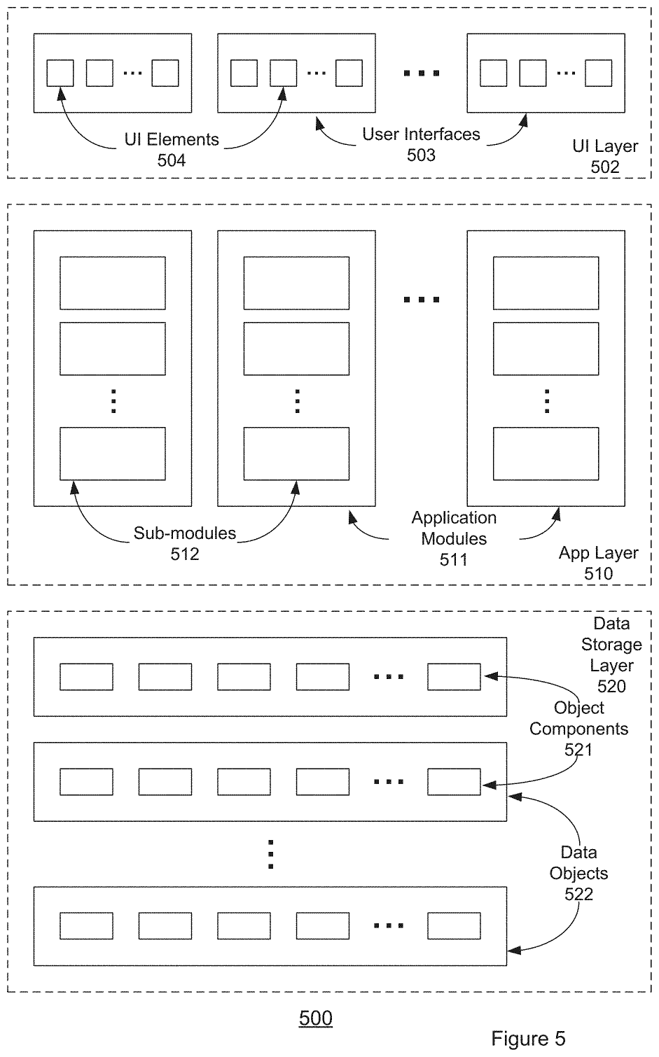

In some embodiments, the functionality and services provided by the system, apparatuses, and methods disclosed herein may be made available to multiple users by accessing an account maintained by a server or service platform. Such a server or service platform may be termed a form of Software-as-a-Service (SaaS). FIG. 3 is a diagram illustrating a SaaS system in which an embodiment may be implemented. FIG. 4 is a diagram illustrating elements or components of an example operating environment in which an embodiment may be implemented. FIG. 5 is a diagram illustrating additional details of the elements or components of the multi-tenant distributed computing service platform of FIG. 4, in which an embodiment may be implemented.

In some embodiments, the disclosed system or services for evaluating a classifier may be implemented as microservices, processes, workflows or functions performed in response to the submission of a set of input data. The microservices, processes, workflows or functions may be performed by a server, data processing element, platform, or system. In some embodiments, the data analysis and other services may be provided by a service platform located “in the cloud”. In such embodiments, the platform may be accessible through APIs and SDKs. The functions, processes and capabilities disclosed herein and with reference to one or more of the Figures or descriptions may be provided as microservices within the platform. The interfaces to the microservices may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts or users, such an architecture may also be used to deliver other types of data processing services and provide access to other applications. For example, such an architecture may be used to provide an evaluation of the performance of a classifier, as disclosed herein. Although in some embodiments, a platform or system of the type illustrated in FIGS. 3-5 may be operated by a 3^{rd} party provider to provide a specific set of services or applications, in other embodiments, the platform may be operated by a provider and a different entity may provide the applications or services for users through the platform.

FIG. 3 is a diagram illustrating a system 300 in which an embodiment may be implemented or through which an embodiment of the disclosed functions and services may be accessed. In accordance with the advantages of an application service provider (ASP) hosted business service system (such as a multi-tenant data processing platform), users of the services may comprise individuals, businesses, stores, or organizations, as examples. A user may access the services using any suitable client, including but not limited to desktop computers, laptop computers, tablet computers, scanners, or smartphones, as examples. In general, a client device having access to the Internet may be used to provide data to the platform for processing and evaluation. A user interfaces with the service platform across the Internet 308 or other suitable communications network or combination of networks. Examples of suitable client devices include desktop computers 303, smartphones 304, tablet computers 305, or laptop computers 306.

System 310, which may be hosted by a third party, may include a set of data analysis and other services to assist in evaluating the performance of a classifier 312, and a web interface server 314, coupled as shown in FIG. 3. It is to be appreciated that either or both the data analysis and services 312 and the web interface server 314 may be implemented on one or more different hardware systems and components, even though represented as singular units in FIG. 3. Classifier Evaluation Services 312 may include one or more functions or operations for the processing of data to enable the evaluation of a classifier.

As examples, in some embodiments, the set of functions, operations or services 312 made available through the platform or system 310 may include:
Account Management services 316, such as
   a process or service to authenticate a user wishing to submit a set of data and a classifier model or models for analysis and evaluation;
   a process or service to generate a container or instantiation of the data analysis and classifier evaluation services;
Initial Evaluation of Data services 318, such as
   a process or service to obtain or receive a (1^{st}) set of pairs of data for processing, where each pair comprises a data element for a 1^{st} and 2^{nd} mode of data from a common study;
   a process or service to determine if labeling or annotating one mode of data in a pair is less “expensive” than labeling or annotating the other mode of data in the pair;
      where the cost or expense of annotation may be reflected in human labor, time, computational resources, data storage resources, or another source of cost;
Evaluate 1^{st} Classifier and 2^{nd} Classifier services 320, such as
   a process or service to evaluate the performance of a classifier for the less expensive mode of data to annotate;
   a process or service to obtain a 2^{nd} set of pairs of data, where each pair comprises a data element of the 1^{st} mode and a data element of the 2^{nd} mode;
      The 2^{nd} set of data pairs may be the same or a subset of the 1^{st} set of data pairs or may be a distinct set of data pairs;
   a process or service to operate the classifier for the less expensive mode of data to annotate on the 2^{nd} set of data pairs to select a subset of that data indicating the presence and the absence of the characteristic the classifiers are attempting to detect;
   a process or service to operate the classifier for the more expensive mode of data to annotate on the selected subset of data indicating the presence and the absence of the characteristic;
   a process or service to estimate the performance of the classifier for the more expensive mode of data to annotate based on the output of the classifier for the more expensive mode as compared to the output of the classifier for the less expensive mode;
      in some embodiments, this may comprise direct estimation of matrix elements when labeling costs are “high” or the prevalence of positive studies is low, or this may comprise use of Bayes rule when labeling costs are “low” or the prevalence of positive studies is high;
Administrative services 322, such as
   a process or services to provide platform and services administration—for example, to enable the provider of the services and/or the platform to administer and configure the processes and services provided to users, such as the logic used to determine the less expensive data mode, the number of positive or negative classifier outputs used in selecting the subset of data pairs, etc.

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is often a combination of hardware and the software that helps deliver content, commonly by hosting a website, to client web browsers that access the web server via the Internet.

FIG. 4 is a diagram illustrating elements or components of an example operating environment 400 in which an embodiment may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented at least in part by one or more of the computing devices. Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, or causing the execution of specific data processing operations, as examples. Each application server (or other form of processing) tier 420 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the data analysis and evaluation services and processing described herein) are provided to users, with each business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment may be implemented. FIG. 5 represents an example of a software architecture which may be used to implement an embodiment. In general, an embodiment may be implemented using a set of software instructions that are designed to be executed by a suitably programmed processing element (such as a CPU, microprocessor, processor, co-processor, controller, or other form of computing device, as non-limiting examples). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrolibars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing business related data processing and services to a user of the platform). Such function, method, process, or operation may include those used to implement one or more aspects of the disclosed system and methods, such as for one or more of the processes or functions described with reference to the Figures or otherwise disclosed herein:
Obtain a 1^{st} set of Data Pairs for a 1^{st} and 2^{nd} Mode of Data from a Common Study;
   In some embodiments, each pair is of an image (x-ray, CT, scan) and a written or text “report” indicating the presence or absence of a characteristic of the image. The characteristic may be the presence or absence of a nodule, a tumor, a person, an animal, an event, a sign, a specific type of signal, etc. displayed in an image or waveform (as examples);
      In other embodiments, the 1^{st} and 2^{nd} mode of data may comprise video and audio, video and text, audio and text, or time-varying electronic signals and text indicating the presence of a target, as non-limiting examples;
Determine if Labeling or Annotating One Mode of Data in a Pair Is Less “Expensive” Than Labeling or Annotating the Other Mode of Data in the Pair;
   For example, a written report may be relatively less expensive to label by indicating whether the report indicates the presence or absence of the characteristic versus evaluating a complex image, where “cost” may be a function of human labor, data storage, time, or computational resources required, as examples;
Evaluate The Performance of a Classifier For The Less Expensive Data Mode, Where This May Include One or More of The Following;
   Label or Annotate the Less “Expensive” Mode of the Data Pair as Indicating the Presence or Absence of the Characteristic;
   Operate the Classifier for the Less Expensive Mode to Select a Subset 1 of Data Indicating the Presence and Absence of the Characteristic (based on outputs of the classifier);
   Review, Label, or Annotate Subset 1 of Data by a Person to Produce a Set of Correctly Labeled Data of the Less Expensive Mode;
   Based on the Correctly Labeled Data, Evaluate the Performance of the Classifier for the Less Expensive Mode (e.g., determine the PPV and NPV for that Classifier);
Obtain a 2^{nd} Set of Data Pairs for the 1^{st} and 2^{nd} Modes of Data;
Operate the Classifier for the Less Expensive Data Mode to Select a Subset 2 of Data from the 2^{nd} Set Indicating the Presence or Absence of the Characteristic;
Operate the Classifier for the More Expensive Data Mode on the Subset 2 of Data;
Estimate the Performance of the Classifier for the More Expensive Mode of Data Based on the Output of the Classifier for the More Expensive Mode Compared to the Output of the Classifier for the Less Expensive Mode;
   As described herein, this may be based on direct estimation of matrix elements when labeling costs are high or the prevalence of positive study results are low or be based on application of the Bayes rule when labeling costs are low or the prevalence of positive study results are high.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

In some embodiments, certain of the methods, processes, operations, or functions disclosed herein may be implemented in the form of a trained neural network or a model generated using a machine learning (ML) algorithm. The machine learning algorithm may be implemented by the execution of a set of computer-executable instructions. The instructions may be stored in (or on) a non-transitory computer-readable medium and executed by a programmed processor, co-processor, or other form of processing element. The set of instructions may be conveyed to a user through a transfer of instructions or an application that executes a set of instructions over a network (e.g., the Internet). The set of instructions or an application may be utilized by an end-user through access to a SaaS platform, self-hosted or on-premise software, or a service provided through a remote platform, as examples.

A trained neural network, trained machine learning model, or other form of decision or classification process may be used to implement one or more of the methods, functions, processes, or operations disclosed herein. Note that a neural network or deep learning model may be characterized in the form of a data structure in which are stored data representing a set of layers containing nodes, and (weighted) connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”. Each layer has neurons that respond to different combinations of inputs from the previous layers. Training of a network is performed using a “labelled” dataset of inputs in an assortment of representative input patterns that are associated with the intended output response. Training uses general-purpose methods to iteratively determine the weights for intermediate and final feature neurons. In terms of a computational model, each neuron may calculate the dot product of inputs and weights, adds the bias, and apply a non-linear trigger or activation function (for example, a sigmoid response function).

Machine learning (ML) is being used to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or example, in the form of one or more parameters, variables, characteristics or “features”) of the set of training data is associated with a label or annotation that defines how the element should be classified by a trained model. When trained, a model will operate on a new element of input data to generate the correct label or classification as an output.

The disclosure includes the following clauses and embodiments:

1. A method, comprising:

obtaining a first set of pairs of data, wherein each pair of data in the first set comprises a first data element and a second data element, the first data element being a first mode of data and the second data element being a second mode of data, wherein the first and the second data elements of the first set are obtained from a first study;

determining which of the first or second mode of data requires fewer resources to label or annotate;

evaluating a performance of a classifier for the mode of data requiring fewer resources to label or annotate;

obtaining a second set of pairs of data, wherein each pair of data in the second set comprises a first data element and a second data element, the first data element being of the first mode of data and the second data element being of the second mode of data, wherein the first and the second data elements of the second set are obtained from a second study;

operating the classifier for the mode of data requiring fewer resources to label or annotate using the data element of the second set of pairs of data corresponding to the mode of data requiring fewer resources to label or annotate as inputs;

selecting a subset of the second set of pairs of data, wherein the subset selected are those for which the classifier for the mode of data requiring fewer resources to label or annotate outputs a result indicating a presence of a characteristic;

selecting a subset of the second set of pairs of data, wherein the subset selected are those for which the classifier for the mode of data requiring fewer resources to label or annotate outputs a result indicating an absence of the characteristic;

operating a classifier for the mode of data requiring greater resources to label or annotate using the selected subset of the second set of pairs of data as inputs; and

estimating a performance of the classifier for the mode of data requiring greater resources to label or annotate by comparing the output of the classifier for the mode requiring greater resources to the output of the classifier for the mode requiring fewer resources to label or annotate.

2. The method of clause 1, wherein the first mode of data is an image, and the second mode of data is a text description indicating the presence or absence of the characteristic in the image.

3. The method of clause 2, wherein the image is an x-ray or scan of a portion of a person's body, and the characteristic is a tumor or nodule in the image.

4. The method of clause 1, wherein determining which of the first or second mode of data requires fewer resources to label or annotate comprises determining if labeling or annotating one mode of data requires greater monetary cost, computational resources, human labor, or time than the other mode of data.

5. The method of clause 1, wherein estimating the performance of the classifier for the mode of data requiring greater resources to label or annotate by comparing the output of the classifier for the mode requiring greater resources to the output of the classifier for the mode requiring fewer resources to label or annotate further comprises performing a direct estimation of a conditional probability distribution or utilizing a form of Bayes rule.

6. The method of clause 1, wherein the first mode of data is an audio track, and the second mode of data is a text description of the audio track.

7. The method of clause 1, wherein the first mode of data is an image, and the second mode of data is a caption for the image.

8. The method of clause 1, wherein evaluating the performance of the classifier for the mode of data requiring fewer resources to label or annotate further comprises:

labeling a plurality of data elements of the mode of data requiring fewer resources to annotate or label, the label indicating the presence or absence of the characteristic;

operating the classifier for the mode of data requiring fewer resources to label or annotate using the data element of the first set of pairs of data corresponding to the mode of data requiring fewer resources to label or annotate as inputs;

selecting a plurality of outputs of the operated classifier for the mode of data requiring fewer resources to label or annotate indicating the presence of the characteristic;

selecting a plurality of outputs of the operated classifier for the mode of data requiring fewer resources to label or annotate indicating the absence of the characteristic;

performing a review of the plurality of outputs of the operated classifier for the mode of data requiring fewer resources to label or annotate indicating the presence of the characteristic and of the plurality of outputs of the operated classifier for the mode of data requiring fewer resources to label or annotate indicating the absence of the characteristic to produce a set of correctly labeled data of the mode requiring fewer resources; and

based on the correctly labeled data, evaluating the performance of the classifier for the mode requiring fewer resources in terms of the PPV and NPV for that classifier.

9. A system, comprising:

a set of computer-executable instructions stored in a memory;

one or more electronic processors configured to execute the set of computer-executable instructions, wherein when executed, the instructions cause the one or more electronic processors to
obtain a first set of pairs of data, wherein each pair comprises a first data element of a first mode of data and a second data element of a second mode of data, wherein both the first and the second modes of data are obtained from a first study;
determine if labeling or annotating one of either the first or second modes of data requires fewer resources than the other mode of data in the pairs;
evaluate a performance of a classifier for the mode of data requiring fewer resources;
obtain a second set of the pairs of data, wherein each pair comprises a first data element of the first mode of data and a second data element of the second mode of data, wherein both the first and the second modes of data in the second set of pairs of data are obtained from a second study;
operate the classifier for the mode of data requiring fewer resources and selecting a subset of pairs of data from the second set of pairs of data, wherein the subset selected represents inputs to the classifier for which the classifier outputs a result indicating a presence of a characteristic and a result indicating an absence of the characteristic;
operate a classifier for the mode of data requiring greater resources using the selected subset of pairs of data; and
estimate a performance of the classifier for the mode of data requiring greater resources based on the output of the classifier for the mode requiring greater resources compared to the output of the classifier for the mode requiring fewer resources.

10. The system of clause 9, wherein the first mode of data is an image, and the second mode of data is a written or text report indicating the presence or absence of a characteristic of the image.

11. The system of clause 10, wherein the image is an x-ray or scan of a portion of a person's body, and the characteristic is a tumor or nodule in the image.

12. The system of clause 9, wherein determining if labeling or annotating one of either the first or second modes of data requires fewer resources than the other mode of data in the pairs comprises determining if the labeling or annotating one mode of data requires more monetary cost, computational resources, human labor, or time than the other mode of data.

13. The system of clause 9, wherein estimating the performance of the classifier for the more mode of data requiring greater resources based on the output of the classifier for the more mode requiring greater resources compared to the output of the classifier for the mode requiring fewer resources further comprises performing a direct estimation of conditional probability distributions or utilizing a form of Bayes rule.

14. The system of clause 9, wherein evaluating the performance of the classifier for the mode of data requiring fewer resources further comprises:

labeling a set of the mode requiring fewer resources of the data pair as indicating the presence or absence of a characteristic;

operating the classifier for the mode requiring fewer resources to select a first subset of data indicating the presence and the absence of the characteristic;

reviewing the first subset of data by a human to produce a set of correctly labeled data of the mode requiring fewer resources; and

based on the correctly labeled data by the human, evaluating the performance of the classifier for the mode requiring fewer resources in terms of the PPV and NPV for that classifier.

15. A non-transitory computer readable medium containing a set of computer-executable instructions, wherein when the set of instructions are executed by one or more electronic processors, the instructions cause the processors to:

obtain a first set of pairs of data, wherein each pair comprises a first data element of a first mode of data and a second data element of a second mode of data, wherein both the first and the second modes of data are obtained from a first study;

determine if labeling or annotating one of either the first or second modes of data requires fewer resources than the other mode of data in the pairs;

evaluate a performance of a classifier for the mode of data requiring fewer resources;

obtain a second set of the pairs of data, wherein each pair comprises a first data element of the first mode of data and a second data element of the second mode of data, wherein both the first and the second modes of data in the second set of pairs of data are obtained from a second study;

operate the classifier for the mode of data requiring fewer resources and selecting a subset of pairs of data from the second set of pairs of data, wherein the subset selected represents inputs to the classifier for which the classifier outputs a result indicating a presence of a characteristic and a result indicating an absence of the characteristic;

operate a classifier for the mode of data requiring greater resources using the selected subset of pairs of data; and

estimate a performance of the classifier for the mode of data requiring greater resources based on the output of the classifier for the mode requiring greater resources compared to the output of the classifier for the mode requiring fewer resources.

16. The non-transitory computer readable medium of clause 15, wherein the first mode of data is an image, and the second mode of data is a written or text report indicating the presence or absence of a characteristic of the image.

17. The non-transitory computer readable medium of clause 16, wherein the image is an x-ray or scan of a portion of a person's body, and the characteristic is a tumor or nodule in the image.

18. The non-transitory computer readable medium of clause 15, wherein determining if labeling or annotating one of either the first or second modes of data requires fewer resources than the other mode of data in the pairs comprises determining if the labeling or annotating one mode of data requires more monetary cost, computational resources, human labor, or time than the other mode of data.

19. The non-transitory computer readable medium of clause 15, wherein estimating the performance of the classifier for the more mode of data requiring greater resources based on the output of the classifier for the more mode requiring greater resources compared to the output of the classifier for the mode requiring fewer resources further comprises performing a direct estimation of matrix elements or utilizing a form of Bayes rule.

20. The non-transitory computer readable medium of clause 15, wherein evaluating the performance of the classifier for the mode of data requiring fewer resources further comprises:

labeling a set of the mode requiring fewer resources of the data pair as indicating the presence or absence of a characteristic;

operating the classifier for the mode requiring fewer resources to select a first subset of data indicating the presence and the absence of the characteristic;

reviewing the first subset of data by a human to produce a set of correctly labeled data of the mode requiring fewer resources; and

based on the correctly labeled data by the human, evaluating the performance of the classifier for the mode requiring fewer resources in terms of the PPV and NPV for that classifier.

The disclosure can be implemented in the form of control logic using computer software in a modular or integrated manner. Based on the disclosure and teachings provided herein, a person of ordinary skill in the art will know and appreciate other ways and/or methods to implement an embodiment using hardware, software, or a combination of hardware and software.

The software components, processes or functions disclosed may be implemented as software code to be executed by a processor using a suitable computer language such as Python, Java, JavaScript, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow a processing element or processor to access computer-executable process steps, application programs and the like, stored on removable and non-removable memory media, to off-load data from a device or to upload data to a device. As mentioned, with regards to the embodiments disclosed herein, a non-transitory computer-readable medium may include almost any structure, technology, or method apart from a transitory waveform or similar medium.

Certain implementations of the disclosure are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, may be implemented by computer-executable program instructions. Note that in some embodiments, one or more of the blocks, stages, or steps may not need to be performed in the order presented or may not need to be performed at all to implement an embodiment of the disclosure.

The computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus implement one or more of the functions, operations, processes, or methods disclosed herein. The computer program instructions may also be stored in a computer-readable memory that may direct a computer or other programmable data processing apparatus to function in a specific manner, such that the instructions stored in the computer-readable memory produce an article of manufacture including instructions that implement one or more of the functions, operations, processes, or methods disclosed herein.

While embodiments of the disclosure have been described in connection with what is presently considered to be the most practical implementation, it is understood that the disclosure is not to be limited to those implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to represent one or more implementations of an embodiment, and to enable a person skilled in the art to practice one or more embodiments of the disclosure, including making and using devices or systems and performing the incorporated methods. The patentable scope of the disclosure is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein.

All methods described herein may be performed in any suitable order unless otherwise indicated herein or clearly contradicted by context. The use of all examples, or exemplary language (e.g., “such as”) provided herein, is intended to better illuminate embodiments of the disclosure, and do not pose a limitation to the scope of the disclosure unless otherwise claimed. No language in the specification should be construed as indicating any non-claimed element as essential to each embodiment of the disclosure.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the disclosure have been described for illustrative and not restrictive purposes, and alternative embodiments will become apparent to readers of the specification and consideration of the figures. Accordingly, the disclosure is not limited to the embodiments described above or depicted in the drawings, and various embodiments and modifications may be made without departing from the scope of the claims below.

That which is claimed is:

1. A method, comprising:
obtaining a first set of pairs of data, wherein each pair of data in the first set comprises a first data element and a second data element, the first data element being a first mode of data and the second data element being a second mode of data, wherein the first and the second data elements of the first set are obtained from a first study;
determining which of the first or second mode of data requires fewer resources to label or annotate;
evaluating a performance of a classifier for the mode of data requiring fewer resources to label or annotate;
obtaining a second set of pairs of data, wherein each pair of data in the second set comprises a first data element and a second data element, the first data element being of the first mode of data and the second data element being of the second mode of data, wherein the first and the second data elements of the second set are obtained from a second study;
operating the classifier for the mode of data requiring fewer resources to label or annotate using the data element of the second set of pairs of data corresponding to the mode of data requiring fewer resources to label or annotate as inputs;
selecting a subset of the second set of pairs of data, wherein the subset selected are those for which the classifier for the mode of data requiring fewer resources to label or annotate outputs a result indicating a presence of a characteristic;
selecting a subset of the second set of pairs of data, wherein the subset selected are those for which the classifier for the mode of data requiring fewer resources to label or annotate outputs a result indicating an absence of the characteristic;
operating a classifier for the mode of data requiring greater resources to label or annotate using the selected subset of the second set of pairs of data as inputs; and
estimating a performance of the classifier for the mode of data requiring greater resources to label or annotate by comparing the output of the classifier for the mode requiring greater resources to the output of the classifier for the mode requiring fewer resources to label or annotate.

2. The method of claim 1, wherein the first mode of data is an image, and the second mode of data is a text description indicating the presence or absence of the characteristic in the image.

3. The method of claim 2, wherein the image is an x-ray or scan of a portion of a person's body, and the characteristic is a tumor or nodule in the image.

4. The method of claim 1, wherein determining which of the first or second mode of data requires fewer resources to label or annotate comprises determining if labeling or annotating one mode of data requires greater monetary cost, computational resources, human labor, or time than the other mode of data.

5. The method of claim 1, wherein estimating the performance of the classifier for the mode of data requiring greater resources to label or annotate by comparing the output of the classifier for the mode requiring greater resources to the output of the classifier for the mode requiring fewer resources to label or annotate further comprises performing a direct estimation of a conditional probability distribution or utilizing a form of Bayes rule.

6. The method of claim 1, wherein the first mode of data is an audio track, and the second mode of data is a text description of the audio track.

7. The method of claim 1, wherein the first mode of data is an image, and the second mode of data is a caption for the image.

8. The method of claim 1, wherein evaluating the performance of the classifier for the mode of data requiring fewer resources to label or annotate further comprises:
labeling a plurality of data elements of the mode of data requiring fewer resources to annotate or label, the label indicating the presence or absence of the characteristic;
operating the classifier for the mode of data requiring fewer resources to label or annotate using the data element of the first set of pairs of data corresponding to the mode of data requiring fewer resources to label or annotate as inputs;
selecting a plurality of outputs of the operated classifier for the mode of data requiring fewer resources to label or annotate indicating the presence of the characteristic;
selecting a plurality of outputs of the operated classifier for the mode of data requiring fewer resources to label or annotate indicating the absence of the characteristic;
performing a review of the plurality of outputs of the operated classifier for the mode of data requiring fewer resources to label or annotate indicating the presence of the characteristic and of the plurality of outputs of the operated classifier for the mode of data requiring fewer resources to label or annotate indicating the absence of the characteristic to produce a set of correctly labeled data of the mode requiring fewer resources; and
based on the correctly labeled data, evaluating the performance of the classifier for the mode requiring fewer resources in terms of the PPV and NPV for that classifier.

9. A system, comprising:
a set of computer-executable instructions stored in a memory;
one or more electronic processors configured to execute the set of computer-executable instructions, wherein when executed, the instructions cause the one or more electronic processors to
obtain a first set of pairs of data, wherein each pair comprises a first data element of a first mode of data and a second data element of a second mode of data, wherein both the first and the second modes of data are obtained from a first study;
determine if labeling or annotating one of either the first or second modes of data requires fewer resources than the other mode of data in the pairs;
evaluate a performance of a classifier for the mode of data requiring fewer resources;
obtain a second set of the pairs of data, wherein each pair comprises a first data element of the first mode of data and a second data element of the second mode of data, wherein both the first and the second modes of data in the second set of pairs of data are obtained from a second study;
operate the classifier for the mode of data requiring fewer resources and selecting a subset of pairs of data from the second set of pairs of data, wherein the subset selected represents inputs to the classifier for which the classifier outputs a result indicating a presence of a characteristic and a result indicating an absence of the characteristic;
operate a classifier for the mode of data requiring greater resources using the selected subset of pairs of data; and
estimate a performance of the classifier for the mode of data requiring greater resources based on the output of the classifier for the mode requiring greater resources compared to the output of the classifier for the mode requiring fewer resources.

10. The system of claim 9, wherein the first mode of data is an image, and the second mode of data is a written or text report indicating the presence or absence of a characteristic of the image.

11. The system of claim 10, wherein the image is an x-ray or scan of a portion of a person's body, and the characteristic is a tumor or nodule in the image.

12. The system of claim 9, wherein determining if labeling or annotating one of either the first or second modes of data requires fewer resources than the other mode of data in the pairs comprises determining if the labeling or annotating one mode of data requires more monetary cost, computational resources, human labor, or time than the other mode of data.

13. The system of claim 9, wherein estimating the performance of the classifier for the more mode of data requiring greater resources based on the output of the classifier for the more mode requiring greater resources compared to the output of the classifier for the mode requiring fewer resources further comprises performing a direct estimation of conditional probability distributions or utilizing a form of Bayes rule.

14. The system of claim 9, wherein evaluating the performance of the classifier for the mode of data requiring fewer resources further comprises:
labeling a set of the mode requiring fewer resources of the data pair as indicating the presence or absence of a characteristic;
operating the classifier for the mode requiring fewer resources to select a first subset of data indicating the presence and the absence of the characteristic;
reviewing the first subset of data by a human to produce a set of correctly labeled data of the mode requiring fewer resources; and
based on the correctly labeled data by the human, evaluating the performance of the classifier for the mode requiring fewer resources in terms of the PPV and NPV for that classifier.

15. A non-transitory computer readable medium containing a set of computer-executable instructions, wherein when the set of instructions are executed by one or more electronic processors, the instructions cause the processors to:
obtain a first set of pairs of data, wherein each pair comprises a first data element of a first mode of data and a second data element of a second mode of data, wherein both the first and the second modes of data are obtained from a first study;
determine if labeling or annotating one of either the first or second modes of data requires fewer resources than the other mode of data in the pairs;
evaluate a performance of a classifier for the mode of data requiring fewer resources;
obtain a second set of the pairs of data, wherein each pair comprises a first data element of the first mode of data and a second data element of the second mode of data, wherein both the first and the second modes of data in the second set of pairs of data are obtained from a second study;
operate the classifier for the mode of data requiring fewer resources and selecting a subset of pairs of data from the second set of pairs of data, wherein the subset selected represents inputs to the classifier for which the classifier outputs a result indicating a presence of a characteristic and a result indicating an absence of the characteristic;
operate a classifier for the mode of data requiring greater resources using the selected subset of pairs of data; and
estimate a performance of the classifier for the mode of data requiring greater resources based on the output of the classifier for the mode requiring greater resources compared to the output of the classifier for the mode requiring fewer resources.

16. The non-transitory computer readable medium of claim 15, wherein the first mode of data is an image, and the second mode of data is a written or text report indicating the presence or absence of a characteristic of the image.

17. The non-transitory computer readable medium of claim 16, wherein the image is an x-ray or scan of a portion of a person's body, and the characteristic is a tumor or nodule in the image.

18. The non-transitory computer readable medium of claim 15, wherein determining if labeling or annotating one of either the first or second modes of data requires fewer resources than the other mode of data in the pairs comprises determining if the labeling or annotating one mode of data requires more monetary cost, computational resources, human labor, or time than the other mode of data.

19. The non-transitory computer readable medium of claim 15, wherein estimating the performance of the classifier for the more mode of data requiring greater resources based on the output of the classifier for the more mode requiring greater resources compared to the output of the classifier for the mode requiring fewer resources further comprises performing a direct estimation of matrix elements or utilizing a form of Bayes rule.

20. The non-transitory computer readable medium of claim 15, wherein evaluating the performance of the classifier for the mode of data requiring fewer resources further comprises:
labeling a set of the mode requiring fewer resources of the data pair as indicating the presence or absence of a characteristic;
operating the classifier for the mode requiring fewer resources to select a first subset of data indicating the presence and the absence of the characteristic;
reviewing the first subset of data by a human to produce a set of correctly labeled data of the mode requiring fewer resources; and
based on the correctly labeled data by the human, evaluating the performance of the classifier for the mode requiring fewer resources in terms of the PPV and NPV for that classifier.
